(19) United States
(12) Patent Application Publication
(10) Pub. No.: US 2015/0166841 A1
(43) Pub. Date: Jun. 18, 2015

(54) TRANSPARENT ADHESIVE SHEET

(71) Applicant: 3M INNOVATIVE PROPERTIES COMPANY, St. Paul, MN (US)

(72) Inventors: Saori Ueda, Kanaawa-ken (JP); Toshihiro Suwa, Tokyo (JP); Shunsuke Suzuki, Tokyo (JP); Jun Fujita, Tokyo (JP)

(73) Assignee: 3M INNOVATIVE PROPERTIES COMPANY, St. Paul, MN (US)

(21) Appl. No.: 14/413,295

(22) PCT Filed: Jul. 9, 2013
(86) PCT No.: PCT/US2013/049665

§ 371 Date: Jan. 7, 2015

(30) Foreign Application Priority Data
Jul. 12, 2012 (JP) 2012-156402

(51) Int. Cl. C09J 7/00; B32B 27/36; B32B 38/00; C09J 11/06; C08K 5/3492; B32B 37/12; B32B 7/12; C09J 4/00

(52) U.S. Cl. CPC C09J 7/00; B32B 7/12; B32B 27/36; C09J 4/00; C09J 11/06; C08K 5/3492; B32B 37/1284; B32B 38/0008; B32B 2250/02; B32B 2255/10; B32B 2255/26; B32B 2307/412; B32B 2457/20; C09J 2201/606; C09J 2433/00; B32B 2037/1246

(57) ABSTRACT

A transparent pressure sensitive adhesive sheet with a front surface and a back surface, fabricated by changing the intensity of the ultraviolet light irradiation between the front surface and the back surface. The transparent pressure sensitive adhesive sheet is obtained by ultraviolet light irradiation of an ultraviolet light hardening pressure sensitive adhesive sheet that contains a (meth)acrylic copolymer, a cleavage type photoinitiator, and an ultraviolet light absorber. The amount of ultraviolet light irradiation varies between the first surface and the second surface and the adhesive force varies between the first surface and the second surface.

### TECHNICAL FIELD

The present invention relates to a transparent adhesive sheet, a laminate body, and a manufacturing method thereof.

### BACKGROUND

Optical members such as image display modules, touch panels, and the like of electronic devices such as movable portable terminals, computer displays, and the like are often laminated with a glass or plastic film as a surface protective layer. In recent years, a method of improving the clarity of the image and increasing the transparency has become widely used, wherein the space between the surface protective layer and the image display module or touch panel is replaced by a transparent material such that the difference in the refractive index compared to the display surface of the surface protective layer, touch panel, or image display module is small (in other words a transparent material with a refractive index similar to glass or plastic). As the transparent material, a pressure sensitive adhesive can be processed beforehand to a predetermined shape and then overlaid, and because the transparent material has sufficient adhesive force and can be relaid it is effective for overlaying a surface protective layer on an image display module or touch panel.

When using a pressure sensitive adhesive, in order to increase image clarity, bubbling in the pressure sensitive adhesive is suppressed by increasing the modulus of the pressure sensitive adhesive. However, problems may occur when the modulus is increased, in that the pressure sensitive adhesive may peel from the adherend, or the adherend may warp, or the like. In particular, if the adherend is a material that easily contracts due to environmental temperature and humidity, the aforementioned problems will be pronounced.

On the other hand, a transparent pressure sensitive adhesive sheet made of a single layer containing a (meth)acrylic acid ester copolymer and a hydrogen abstraction photoinitiator has been proposed in Japanese Unexamined Patent Application Publication No. 2006-299053 as a double-sided pressure sensitive adhesive sheet that can be overlaid on different types of materials.

### SUMMARY

One embodiment of the present disclosure provides a transparent pressure sensitive adhesive sheet that has a first surface and a second surface, obtained by ultraviolet light irradiation of an ultraviolet light hardening pressure sensitive adhesive sheet that contains a (meth)acrylic copolymer, a cleavage type photoinitiator, and an ultraviolet light absorber. The amount of ultraviolet light irradiation varies between the first surface and the second surface and an adhesive force varies between the first surface and the second surface.

Furthermore, another embodiment of the present disclosure provides a laminate body that includes a first substrate, a second substrate made of a different material than the first substrate, and the aforementioned transparent pressure sensitive adhesive sheet with a first surface that is overlaid onto the surface of the first substrate, and a second surface that is overlaid onto the surface of the second substrate.

Furthermore, another embodiment of the present disclosure provides a method for producing a laminate body having a first substrate, a second substrate, and the aforementioned transparent pressure sensitive adhesive sheet provided between the first substrate and the second substrate. The method includes a step of placing the ultraviolet light hardening pressure sensitive adhesive sheet adjacent to the first substrate, a step of placing the second substrate adjacent to the ultraviolet light hardening pressure sensitive adhesive sheet, a step of heating and/or compressing the ultraviolet light hardening pressure sensitive adhesive sheet and causing this sheet to track the contours of at least one of the first and second substrate, and a step of irradiating ultraviolet light at different amounts of ultraviolet light radiation onto the first surface and second surface of the ultraviolet light hardening pressure sensitive adhesive sheet.

### DETAILED DESCRIPTION

The present inventors have developed a transparent pressure sensitive adhesive sheet produced by changing the intensity of ultraviolet light radiation between a front surface and a back surface when there is a need to change the pressure sensitive adhesive performance between the front surface and the back surface for a pressure sensitive adhesive sheet that bonds to adherends that require suppression of peeling at the interface with the pressure sensitive adhesive sheet, and to adherends that require suppression of bubbling at the interface with the pressure sensitive adhesive sheet.

However, performing ultraviolet light radiation includes not only the case of direct irradiation onto an ultraviolet light hardening pressure sensitive adhesive sheet, but also cases where irradiation is performed through a transparent peeling film that protects an ultraviolet light hardening pressure sensitive adhesive sheet, and cases where and ultraviolet light hardening pressure sensitive adhesive sheet is overlaid onto a transparent adherend, and then irradiation is performed through the transparent adherend or irradiation is performed through a separate transparent body provided therebetween. Ultraviolet light may be absorbed in the transparent body depending on the wavelength, and there are problems that sufficient hardening will not be possible even after irradiation or that very much time will be required.

Furthermore, even if the intensity of the ultraviolet light irradiation is varied between the front surface and the back surface of the ultraviolet light hardening pressure sensitive adhesive sheet, hardening will inevitably proceed similarly in the front surface and back surface, and there is a problem that there will be almost no difference in the adhesive force between the front surface and the back surface.

A representative embodiment of the present invention is described below in further detail for the purpose of presenting examples, but the present invention is not restricted to these embodiments.

One embodiment of the present disclosure provides a transparent pressure sensitive adhesive sheet obtained by irradiating an ultraviolet light hardening pressure sensitive adhesive sheet containing a (meth)acrylic copolymer, cleavage type photoinitiator, and ultraviolet light absorber at different ultraviolet light amounts on a first surface and a second surface.

The transparent pressure sensitive adhesive sheet of the present disclosure has a different adhesive force on the first surface and the second surface because the amount of ultraviolet light irradiated on the first surface and the second surface differs and thus the degree of hardening is different. The pressure sensitive adhesive sheet of the present disclosure can adjust the adhesive force of the front surface and the back surface to different values by including an ultraviolet light absorber.

The transparent pressure sensitive adhesive sheet of the present disclosure is made by overlaying an ultraviolet light hardening pressure sensitive adhesive sheet which is a preliminary stage onto a transparent adherend and then irradiating ultraviolet light through the transparent adherend in order to increase the adhesive force by ultraviolet light irradiation, and therefore when used in a desired application, temporary fastening and repositioning can easily be performed at a desired stage prior to ultraviolet light irradiation. Therefore, this sheet can be advantageously used in applications where a surface protective layer is overlaid onto a large adherend (for example a large liquid crystal module).

The term “ultraviolet light reactive site” that is used in the present disclosure refers to sites that are activated by ultraviolet light irradiation and that can form cross-links between other sites.

The term “(meth)acrylic” refers to “acrylic” and “methacrylic”, and the term “(meth)acrylate” refers to “acrylate” and “methacrylate”.

The term “adhesive force” refers to the adhesive force when tested by the inclined ball tack method specified in JISZ-0237 using ball No., when tested at an environmental temperature of 23° C., or when tested in conformance with JIS-Z0237 at an environmental temperature of 23° C., where the test plate is a polyethylene terephthalate film (Lumina T60 produced by Toray, 188 μm thick) or polymethylmethacrylate (Acrylite MR200 produced by Mitsubishi Rayon, 1.0 mm×55 mm×85 mm), and the peeling angle is 180°.

The term “storage elasticity” refers to the storage elasticity at a specified temperature when the viscoelastic properties are measured in shear mode at 1 Hz and at a temperature rise rate of 5° C./minute across a temperature range of −40° C. to 200° C.

The various compositions of the ultraviolet light hardening pressure sensitive adhesive sheet prior to ultraviolet light irradiation are described below.

### (Meth)Acrylic Copolymer

The (meth)acrylic copolymer of the present disclosure includes the case where the copolymer itself has ultraviolet light reactive sites and the case where a cross-linking agent that reacts with the (meth)acrylic copolymer has the ultraviolet light reactive sites.

If the copolymer itself has the ultraviolet light reactive sites, the copolymer is activated by ultraviolet light irradiation, and then the cross-link is formed at a different area in the copolymer molecule, or the copolymer has sites that can form a cross-link between different (meth)acrylic copolymer molecules.

If the cross-linking agent that reacts with the methyl acrylic polymer has the ultraviolet light reactive sites, the (meth)acrylic polymer and the cross-linking agent have various types of combinations. An example of a combination is the combination of a (meth)acrylic polymer that has a hydroxyl group as a reactive group, and a cross-linking agent that has an isocyanate group as a reactive group.

The (meth)acrylic copolymers that have a hydroxyl group are not restricted to the following, but for example can be obtained by copolymerizing (meth)acrylate monomer containing one or more type of monomer selected from the group consisting of 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, and 4-hydroxybutyl acrylate.

The amount of (meth)acrylate monomer having a hydroxyl group is generally approximately 5 mass % or higher, approximately 10 mass % or higher, or approximately 20 mass % or higher and approximately 40 mass % or lower, approximately 35 mass % or lower, or approximately 30 mass % or lower, based on the total amount of monomer component.

If the amount of (meth)acrylate monomer having a hydroxyl group is approximately 15 mass % or more based on the total mass of monomer component, the hydrophilicity and water vapor permeability of the pressure sensitive adhesive sheet after hardening and forming by ultraviolet light irradiation will be increased, and whitening of the pressure sensitive adhesive due to moisture absorption can be prevented.

The monomer that is used when polymerizing the (meth)acrylic copolymer of the present disclosure can include alkyl (meth)acrylic acid esters. In a preferable embodiment, the monomer component includes an alkyl (meth)acrylate ester where the number of carbon atoms of the alkyl group is from 2 to 26, from the perspective of having favorable wetting properties with regard to the adherend and providing favorable viscoelasticity to the pressure sensitive adhesive sheet. Examples of this type of alkyl (meth)acrylate ester include (meth)acrylate of non-tertiary alkyl alcohols where the alkyl group has 2 to 26 carbon atoms, blends thereof, and the like. Although not restricted to the following, specific examples that can be preferably used include ethyl acrylate, ethyl methacrylate, n-butyl acrylate, n-butyl methacrylate, isobutyl acrylate, isobutyl methacrylate, hexyl acrylate, hexyl methacrylate, n-octyl acrylate, n-octyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, tridecyl acrylate, tridecyl methacrylate, tetradecyl acrylate, methacrylate, tetradecyl, hexadecyl acrylate, hexadecyl methacrylate, stearyl acrylate, stearyl methacrylate, isostearyl acrylate, isostearyl methacrylate, eicosal acrylate, eicosal methacrylate, hexacosal acrylate, hexacosal methacrylate, 2-methylbutyl acrylate, 4-methyl-2-pentyl acrylate, 4-t-butylcyclohexyl acrylate, cyclohexyl methacrylate, isobornyl acrylate, blends thereof, and the like.

The amount of alkyl (meth)acrylate ester where the number of carbon atoms of the alkyl group is from 2 to 26 is generally approximately 50 mass % or higher, approximately 60 mass % or higher, or approximately 70 mass % or higher and approximately 95 mass % or less, approximately 90 mass % or less, or approximately 80 mass % or less, based on the total mass of monomer component. If the amount of alkyl (meth)acrylate ester where the number of carbon atoms of the alkyl group is from 2 to 26 is approximately 95 mass % or less based on the total mass of the monomer component, the adhesive force of the pressure sensitive adhesive sheet can be favorably ensured, and if the amount is approximately 50 mass % or higher, the elasticity of the pressure sensitive adhesive sheet will be in a suitable range, and the wettability of the pressure sensitive adhesive sheet with regard to the adherend will be favorable.

The monomer component may include other monomers in addition to the aforementioned monomers to the extent that the properties of the pressure sensitive adhesive sheet are not lost. Examples include (meth)acrylic monomers other than the aforementioned, as well as vinyl monomers such as vinyl acetate, vinyl propionate, and styrene and the like.

If the transparent pressure sensitive adhesive sheet of the present disclosure is used under high temperature and high humidity, a (meth)acrylate copolymer that does not contain an acid such as acrylic acid or the like as the monomer component is preferably used in order to prevent whitening of the pressure sensitive adhesive sheet.

The (meth)acrylate copolymer can be formed by polymerizing the monomer components in the presence of a polymerization initiator. The polymerization method is not particularly restricted, and the monomer component can be polymerized by a normal radical polymerization method, such as solution polymerization, emulsion polymerization, suspension polymerization, or bulk polymerization, and the like. Generally, radical polymerization using a thermal polymerization initiator is used. Examples of thermal polymerization initiators include organic peroxides such as benzoyl peroxide, t-butyl perbenzoate, cumene hydroperoxide, diisopropyl peroxydicarbonate, di-n-propyl peroxy dicarbonate, di(2-ethoxyethyl) peroxy dicarbonate, t-butyl peroxy neodecanoate, t-butyl peroxy pivalate, (3,5,5-trimethyl hexanoyl) peroxide, dipropionyl peroxide, diacetyl peroxide, and the like; and azo type compounds such as 2,2′-azobis isobutyronitrile, 2,2′-azobis (2-methyl butyronitrile), 1,1′-azobis (cyclohexane-1-carbonitrile), 2,2′-azobis (2,4-dimethyl valeronitrile), 2,2′-azobis (2,4-dimethyl-4-methoxy valeronitrile), dimethyl 2,2′-azobis (2-methyl propionate), 4,4′azobis (4-cyano valeric acid), 2,2′-azobis (2-hydroxymethyl propionitrile), 2,2′-azobis [2-(2-imidazolin-2-yl) propane], and the like.

The weighted average molecular weight of the (meth)acrylic copolymer is generally approximately 30,000 or higher, approximately 50,000 or higher, or approximately 100,000 or higher, and approximately 1,000,000 or less, approximately 500,000 or less, or approximately 300,000 or less. The value for the weighted average molecular weight in the present disclosure is based on a polystyrene conversion using a gel permeation chromatography method.

The glass transition temperature Tg of the (meth)acrylic copolymer is generally approximately 40° C. or lower, approximately 20° C. or lower, or approximately 0° C. or lower. The value for the glass transition temperature in the present disclosure is based on measuring the dynamic elastoviscosity.

### Cleavage Type Photoinitiator

The cleavage type photoinitiator of the present disclosure absorbs light of a specific wavelength and breaks bonds of locations corresponding to that wavelength. Radicals are generated at two various locations that are broken at this time, and thus a radical reaction begins. Examples of cleavage type photoinitiators include 4-phenoxydichloroacetophenone, 4-t-butyl-dichloro acetophenone, 4-t-butyl-trichloro acetophenone, diethoxyacetophenone, 2-hydroxy-2-methyl-1-phenyl propan-1-one, 1-(4-isopropyl phenyl)-2-hydroxy-2-methyl propan-1-one, 1-(4-dodecyl phenyl)-2-hydroxy-2-methyl propan-1-one, 4-(2-hydroxy ethoxy)-phenyl-(2-hydroxy-2-propyl) ketone, 1-hydroxy cyclohexyl phenyl ketone, 2-methyl-1-(4-(methylthio) phenyl-2-morpholino propane-1, and the like; and benzoin based photoinitiators such as benzoin, benzoin methyl ether, benzoin ethyl ether, benzoin isopropyl ether, benzoin isobutyl ether benzyl methyl ketal, and the like. Examples of commercial cleavage type photoinitiators include those sold under the tradenames Irgacure and Darocur of BASF. Of these cleavage type photoinitiators, those that have a cleavage point that cleaves by light with a wavelength of 300 nm or more are preferably used. This cleavage type photoinitiator absorbs at a wavelength of 300 nm or higher, absorbs light at these wavelengths, and generates radicals to initiate a polymerization reaction of the monomer.

These compounds can be used individually, or two or more types can be blended and used. Furthermore, a cleavage type photoinitiator and a thickening agent can be used in combination. The amount of cleavage type photoinitiator used is generally approximately 0.01 mass % or higher, and approximately 1 mass % or lower, based on the total amount of monomer that forms the (meth)acrylic copolymer.

Although not bound by any theory, if a benzophenone structure is used as the ultraviolet light reactive site, the reaction efficiency has a tendency to drop with long wavelength UV (for example, UV-A with a wavelength from 315 to 380 nm), so light that includes shorter wavelength UV-B (wavelength from 280 to 315 nm) and UV-C (wavelength from 200 to 280 nm) is generally used. However, if ultraviolet light irradiation is performed through a transparent release film that protects the ultraviolet light hardening pressure sensitive adhesive sheet, or ultraviolet light irradiation is performed through the transparent adherend, and then through a separate transparent body is provided therebetween, UV-B and UV-C is absorbed by the transparent body and a sufficient amount of ultraviolet light will not reach the ultraviolet light hardening pressure sensitive adhesive sheet, and much time will be required for cross-linking For example, with a polyethylene terephthalate film that is commonly used for industrial applications, UV-B and UV-C are essentially absorbed.

On the other hand, in the present disclosure, if a cleavage type photoinitiator is used with a cleavage point that essentially cleaves with light of a wavelength of 300 nm or higher, the tack time can be shortened and energy can be conserved, and the step of overlaying on the adherend can be more efficiently performed, even if a separate transparent body is provided therebetween.

### Ultraviolet Light Absorber

The ultraviolet light absorber is a material that absorbs ultraviolet light, and examples that can be used include hydroxyphenyl triazine based ultraviolet light absorbers such as commercial product TINUVIN (registered trademark) 400, commercial product TINUVIN (registered trademark) 405, commercial product TINUVIN (registered trademark) 460, and the like.

By using an ultraviolet light absorber, the degree of hardness of the front surface and the back surface can be sufficiently inclined when different amounts of ultraviolet light are irradiated on the front surface and back surface of the ultraviolet light hardening pressure sensitive adhesive sheet, and thus the adhesive force on the front surface and back surface can have different values.

The amount of ultraviolet light absorber used is generally approximately 0.01 mass % or higher, and approximately 1 mass % or lower, based on the total amount of monomer that forms the (meth)acrylic copolymer.

### Ultraviolet Light Cross-Linking Agent

An ultraviolet light cross-linking agent with ultraviolet light reactive sites can be used. Various structures can be used as structures that act as ultraviolet light reactive sites. In the preferred embodiments, the ultraviolet light reactive sites have an ethylenic unsaturated structure. An ultraviolet light cross-linking agent with an ethylenic unsaturated structure is useful from the perspective that cross-linking can easily be achieved by ultraviolet light irradiation. The ethylenic unsaturated structure can be a structure that contains a (meth)acryloyol group or a structure that contains a vinyl group, or the like. A structure that contains a (meth)acryloyol group is useful from the perspective of reactivity and copolymerization properties.

The ultraviolet light cross-linking agent of the present disclosure can also have an isocyanate group as the reactive group. By having an isocyanate group, the ultraviolet light cross-linking agent can also react with a (meth)acrylic copolymer that has a hydroxyl group in a side chain.

For example, 2-methacryoloxy ethyl isocyanate (Karenz MOI (registered trademark) manufactured by Showa Denko), 2-acryloyoloxy ethyl isocyanate (Karenz AOI (registered trademark) manufactured by Showa Denko), and the like can be used as the ultraviolet light cross-linking agent with an ethylenic unsaturated structure and an isocyanate group.

The ultraviolet light hardening pressure sensitive adhesive sheet of the present disclosure can also contain optional components in addition to the aforementioned components. Examples of optional components include thermal cross-linking agent, fillers, antioxidants, and the like.

The thickness of the ultraviolet light hardening pressure sensitive adhesive sheet can be appropriately determined based on the application, and for example can be from approximately 5 μm to approximately 1 mm.

The ultraviolet light hardening pressure sensitive adhesive sheet can be formed from a blend of various components that are included in the aforementioned ultraviolet light hardening pressure sensitive adhesive sheet, using a conventionally known method such as solution casting, an extruding process, or the like. Furthermore, the ultraviolet light hardening pressure sensitive adhesive sheet can have a release film such as a silicone treated polyester film, polyethylene film, or the like, on one side or both sides thereof.

The transparent pressure sensitive adhesive sheet of the present disclosure has a different adhesive force on the first surface and the second surface. The value when measured using an incline ball tack method is preferably different by 2 or more. When PET or polymethyl methacrylate (PMMA) is used as the test plate, the ratio between the adhesive force of the first surface and the second surface is preferably 1.20 or higher.

Another embodiment of the present disclosure is a laminate body that contains a first substrate, a second substrate, and a transparent pressure sensitive adhesive sheet with a first surface and a second surface, provided between the first substrate and the second substrate, where the first substrate and the second substrate are made of different materials, and the level of ultraviolet light irradiation varies between the first surface and the second surface of the transparent pressure sensitive adhesive sheet. With this laminate body, the adhesive forces are different between the first surface and the second surface of the transparent pressure sensitive adhesive sheet, and therefore appropriate adhesive performance can be demonstrated for the first substrate and the second substrate when these are made of different materials. Examples of the substrate include surface protective layers, image display modules, and touch panels. This type of laminate body can be used as a member that forms a part of products with various types of applications such as image display modules, optical members, and the like.

Examples of surface protective layers include glass plate, polycarbonate resin films, acrylic resin films such as PMMA, and the like.

The image display modules are not restricted to the following, but examples include image display modules such as reflective type and back light type liquid crystal display units, plasma display units, electroluminescence (EL) displays, electronic paper, and the like. The display surface of the image display module can have additional layers (one layer or multiple layers) such as a light polarizing plate (which may have a surface with recesses and protrusions) for example.

Touch panels are transparent thin-film shaped devices, and when a user touches or presses a certain position on the touch panel using a finger or pen (stylus), that position can be detected and specified. Furthermore, when a plurality of points are simultaneously touched, motions such as the subject movements, rotation, image zoom, and the like can be directly input. The position detection method is generally a resistance film method that is operated by the pressure applied on the touch panel, an electrostatic capacitance method that detects the change in electrostatic capacitance between the fingertip and the touch pane, or the like. The touch panel is provided on an image display device such as a CRT display, a liquid crystal display, or the like, and is used in mobile terminals such as ATMs, PCs (personal computer), mobile phone, and portable devices such as PDAs and the like.

In particular, if a touch panel with an Indium Tin Oxide (ITO) layer is used as the substrate, a transparent pressure sensitive adhesive sheet that does not include an acid such as acrylic acid or the like is preferably used. This is because the electrical resistance of the ITO layer is increased if a pressure sensitive adhesive sheet containing an acid is directly overlaid onto the ITO layer.

This type of laminate body can be produced by a method that includes a step of placing the ultraviolet light hardening pressure sensitive adhesive sheet adjacent to the first substrate, a step of placing the second substrate adjacent to the ultraviolet light hardening pressure sensitive adhesive sheet, a step of heating and/or compressing the ultraviolet light hardening pressure sensitive adhesive sheet to track the contour of the first and/or second substrate, and a step of irradiating ultraviolet light at different amounts of ultraviolet light radiation onto the first surface and second surface of the ultraviolet light hardening pressure sensitive adhesive sheet. The order of the steps is not restricted to the aforementioned order. In other words, methods that can be used include a method of irradiating ultraviolet light of different ultraviolet light irradiation levels onto the first surface and second surface of the ultraviolet light hardening pressure sensitive adhesive sheet, and then placing the transparent pressure sensitive adhesive sheet adjacent to the first and/or second substrate, and a method of sandwiching the ultraviolet light hardening pressure sensitive adhesive sheet between the first substrate and the second substrate, heating and/or compressing the ultraviolet light hardening pressure sensitive adhesive sheet, and then irradiating ultraviolet light at different amounts of ultraviolet light radiation for the first surface and the second surface, through the first substrate and/or second substrate.

In the step of heating and/or compressing the pressure sensitive adhesive sheet of the present disclosure, the heating and/or compressing can be performed using a convection oven, hot plate, heat press, heat laminator, autoclave, or the like. In order to enhance the fluidity of the pressure sensitive adhesive sheet so that the pressure sensitive adhesive sheet will more efficiently track the shape of the substrate, compressing is preferably performed at the same time as heating, using a heat laminator, heat press, autoclave, or the like. Compressing with an autoclave is particularly advantageous for removing bubbles from the pressure sensitive adhesive sheet. The heating temperature of the pressure sensitive adhesive sheet can be a temperature where the pressure sensitive adhesive sheet softens or flows to sufficiently track the contour of the substrate, and generally can be approximately 30° C. or higher, approximately 40° C. or higher, or approximately 60° C. or higher, and approximately 150° C. or lower, approximately 120° C. or lower, or approximately 100° C. or lower.

In the step where ultraviolet light is irradiated onto the ultraviolet light hardening pressure sensitive adhesive sheet, irradiation can be performed using a belt conveyor type ultraviolet light irradiating device that uses low-pressure mercury lamps, moderate pressure mercury lamps, high-pressure mercury lamps, ultra-high-pressure mercury lamps, xenon lamps, metal halide lamps, electrode free lamps, LED, and the like as light sources. In this case, the amount of ultraviolet light irradiation is generally approximately 1000 mJ/cm² to approximately 5000 mJ/cm².

The amount of ultraviolet light irradiation on the first surface and second surface of the ultraviolet light hardening pressure sensitive adhesive sheet can be different values, and either a method that irradiates different amounts of ultraviolet light from both surfaces or a method that irradiates ultraviolet light only from one surface can be used.

For example, if the first substrate is an adherend that requires suppression of peeling at the interface with the pressure sensitive adhesive sheet such as PMMA or the like, and the second substrate is an adherend that requires suppression of bubbling at the interface with the pressure sensitive adhesive sheet such as polyethylene terephthalate (PET) and the like, when ultraviolet light is irradiated from only the second surface of the ultraviolet light hardening pressure sensitive adhesive sheet, hardening of the second surface will proceed, and both bubbling at the second substrate and peeling at the first substrate can be simultaneously reduced.

Yet another embodiment of the present disclosure provides an electronic device that includes the aforementioned image display module. These electronic devices are not restricted to the following, but examples include mobile phones, portable information terminals (PDA), portable game devices, electronic book terminals, car navigation systems, portable music players, watches, televisions (TV), video cameras, video players, digital cameras, global positioning system (GPS) devices, personal computers (PC), and the like.

### EXAMPLES

Examples of the present invention are presented below, but the present invention is in no way restricted to these examples. Unless otherwise noted, all parts, percentages, and ratios reported in the following example are on a weight basis.

### Fabricating the Transparent Pressure Sensitive Adhesive Sheet

### Abbreviations

BA: n-butyl acrylate

HEA: 2-hydroxyethyl acrylate

V-65: thermal initiator (2,2′-azole bis(2,4-dimethyl valeronitrile) (produced by Showa Denko)

Irgacure (registered trademark) 184: cleavage type photoinitiator (1-hydroxy cyclohexyl phenyl ketone) (product of Ciba Japan)

Benzophenone (product of Wako Pure Chemical Industries)

Karenz AOI (registered trademark): ultraviolet light cross-linking agent (2-acryloyol oxyethyl isocyanate) (product of Showa Denko)

D201: thermal cross-linking agent (Duranet (registered trademark) D201) (product of Asahi Kasei Chemicals)

Tinuvin (registered trademark) 400: ultraviolet light absorber (product of Ciba Japan)

EtOAc: ethyl acetate

MEK: methyl ethyl ketone

### Fabrication Procedures

### PSA Sheet-1

The ultraviolet light hardening pressure sensitive adhesive sheet (PSA sheet-1) was produced as described below.

A mixture of BA/HEA/EtOAc/MEK/V-65=21.0/9.0/42.0/28.0/0.07 (mass parts) was prepared, and the system was purged with nitrogen for 5 minutes. A reaction was induced for 24 hours in a constant temperature bath at 50° C. to obtain a transparent viscous solution.

Next, 0.6 mass % of D201, 0.5 mass % of Irgacure 184, 1.0 mass % of Karenz AOI, and 0.6 mass % of Tinuvin 400 were added to the polymer solution obtained, based on the total weight of monomer.

Next, the solution that was obtained was coated onto a 50 μm thick release film (duplicate release surface Cerapee 1MIB (T) produced by Toray Advanced Film) using a knife coater adjusted to a gap of 250 μm, and then dried for 10 minutes in an oven at 80° C. The thickness of the dried pressure sensitive adhesive was 50 μm. Next, a 38 μm thick release film (Purex (registered trademark) A-31 produced by Teijin Dupont Film) was laminated onto the surface of the pressure sensitive adhesive to obtain an ultraviolet light hardening pressure sensitive adhesive sheet (transfer type pressure sensitive adhesive tape) (PSA sheet-1).

### PSA Sheet-2 Through Sheet-5

PSA sheet-2 through sheet-5 were produced in the same manner as PSA sheet-1, except that the amount of cross-linking agent, cleavage type photoinitiator, and ultraviolet light absorber that was added was adjusted as shown in Table 1.

### PSA Sheet-6 Through Sheet-8

PSA sheet-6 through sheet-8 were prepared in the same manner as PSA sheet-1, except that the benzophenone was used as the photoinitiator and adjusted as shown in Table 1.

TABLE 1

| | | Karenz | | Tinuvin | |
|---|---|---|---|---|---|
| Sample | D201 | AOI | Irgacure 184 | 400 | Benzophenon |
| PSA sheet-1 | 0.6 | 1.0 | 0.5 | 0.6 | — |
| PSA sheet-2 | 0.3 | 1.0 | 0.5 | 0.6 | — |
| PSA sheet-3 | — | 1.0 | 0.5 | 0.6 | — |
| PSA sheet-4 | 0.3 | 1.0 | 0.5 | — | — |
| PSA sheet-5 | 0.3 | 5.0 | 0.5 | 0.6 | — |
| PSA sheet-6 | — | — | — | — | 0.3 |
| PSA sheet-7 | — | — | — | — | 0.5 |
| PSA sheet-8 | — | — | — | — | 1.0 |

### Example 1

The 38 μm thick release film of PSA sheet-1 was peeled off, and the surface was irradiated with ultraviolet light using an ultraviolet light irradiating device F-300 produced by Fusion UV Systems Japan (H-bulb, 120 W/cm, 15 m/min×20 passes) to obtain the transparent pressure sensitive adhesive sheet of example 1.

### Examples 2 Through 4 and Comparative Example 1

PSA sheets-2, 3, 4, and 5 were irradiated with ultraviolet light by the same procedures as example 1 to obtain transparent pressure sensitive adhesive sheets for examples 2 and 3, comparative example 1, and example 4. For comparative example 1, PSA sheet-4 was used, but without containing an ultraviolet light absorber (Tinuvin 400).

### Evaluation of Adhesive Performance

The transparent pressure sensitive adhesive sheet of examples 1 to 4 and comparative example 1 were evaluated for adhesive performance as described below, with the surface that was irradiated with ultraviolet light as the first surface and a surface on the opposite side as the second surface.

### Inclined Ball Tack Method

The ball number for the inclined ball tack method designated in JIS-Z0237 when tested at an environmental temperature of 23° C. is shown in Table 2.

### Adhesive Force to PET

A 25 μm thick PET film (Lumirror T60, produced by Toray) was laminated onto the surface on the opposite side as the measured surface, and the adhesive force was measured in accordance with JIS-Z0237, using a sample cut to a width of 24 mm. The environmental temperature was 23° C., the test plate was PET (Lumirror T60 produced by Toray, 188 μm thick), and the peeling angle was 180°. The results are shown in Table 2.

### Adhesive Force to PMMA

The measurement was performed similar to the evaluation of adhesive force to PET, except that the test plate was changed to PMMA (Aclylite MR200 produced by Mitsubishi Rayon, 1 mm thick). The results are shown in Table 2.

The difference in the adhesive force between surface 1 and surface 2 was almost nonexistent for comparative example 1 that did not contain ultraviolet light absorbers.

TABLE 2

| | Ball Tack | | | Adhesion to PET | | | Adhesion to PMMA | | |
|---|---|---|---|---|---|---|---|---|---|
| | First | Second | | First | Second | Adhesive | First | Second | Adhesive |
| | surface | surface | | surface | surface | force | surface | surface | force |
| | No. | No. | Diff. | N/inch | N/inch | ratio | N/inch | N/inch | ratio |
| Ex. 1 | 8 | 10 | 2 | 6.40 | 9.53 | 1.49 | 6.26 | 9.22 | 1.47 |
| Ex. 2 | 9 | 13 | 4 | 7.47 | 11.62 | 1.56 | 7.15 | 10.11 | 1.41 |
| Ex. 3 | 9 | 14 | 5 | 9.00 | 12.90 | 1.43 | 8.43 | 10.65 | 1.26 |
| Ex. 4 | 7 | 9 | 2 | 7.23 | 9.11 | 1.26 | 7.14 | 8.75 | 1.23 |
| Comp. Ex. 1 | 9 | 10 | 1 | 7.21 | 7.43 | 1.03 | 6.96 | 7.26 | 1.04 |

### Fabricating the Laminate Body

### Example 5

The ultraviolet light irradiated surface of the transparent pressure sensitive adhesive sheet of example 1 was applied by a rubber roller onto a PET film (Lumirror (registered trademark) T60, produced by Toray, 188 μm thick). The 50 μm release film on the opposite side was peeled off, and a PMMA sheet (Acrylite (registered trademark) MR 200 produced by Mitsubishi Rayon, 1.0 mm×55 mm×85 mm) was applied using a rubber roller. Next, treatment was performed for 30 minutes at 0.5 MPa and 40° C. using an autoclave to obtain the laminate body according to example 5 (PET film/PSA film/PMMA sheet).

### Reference Example 1

The laminate body according to reference example 1 was obtained in a manner similar to example 5, except that the surface of transparent pressure sensitive adhesive sheet that was irradiated with ultraviolet light in example 1 was applied to the PMMA sheet, and the surface on the opposite side was applied to the PET film.

### Examples 6 and 7

The laminate bodies of examples 6 and 7 were obtained in the same manner as example 5, except that the transparent pressure sensitive adhesive sheets of examples 2 and 3 were used.

### Reference Examples 2 and 3

The laminate bodies of reference examples 2 and 3 were obtained in the same manner as reference example 1, except that the transparent pressure sensitive adhesive sheets of examples 2 and 3 were used.

### Comparative Example 2

The 38 μm thick release film was peeled from PSA sheet-1, and then a PET film (Lumirror (registered trademark) T60 produced by Toray, 188 μm thick) was applied by a rubber roller without performing ultraviolet light irradiation. The 50 μm release film on the opposite side was peeled off, and a PMMA sheet (Acrylite (registered trademark) MR 200 produced by Mitsubishi Rayon, 1.0 mm×55 mm×85 mm) was applied using a rubber roller. Next, treatment was performed for 30 minutes at 0.5 MPa and 40° C. using an autoclave to obtain the laminate body according to comparative example 2.

### Comparative Examples 3 and 4

The laminate bodies of comparative examples 3 and 4 were obtained by the same procedures as comparative example 2, except that PSA sheet-2 and sheet-3 were used.

### Comparative Example 5

The laminate body according to comparative example 5 was obtained in a manner similar to example 5, except that the surface of the transparent pressure sensitive adhesive sheet that was irradiated with ultraviolet light in example 1 was applied to the PET film.

### Reliability Tests

The aforementioned laminate bodies were placed in a temperature and humidity chamber at 65° C. and 90% RH and retrieved after 24 hours, and then the appearance was visually observed. If the laminate body was completely peeling, a score of 1 was made; if 50% or more was peeling, a score of 2 was made; if there was slight peeling, a score of 4 was made; and if there was absolutely no peeling, a score of 5 was made. Furthermore, if a plurality of bubbles were found in the pressure sensitive adhesive sheet, a score of 1 was made; if there were only slight bubbles, a score of 4 was made; and if there were absolutely no bubbles, a score of 5 was made. The results are shown in Table 3.

TABLE 3

| | Ultraviolet light | | | | |
|---|---|---|---|---|---|
| | hardening | Ultraviolet | Substrate overlaid | | |
| | pressure sensitive | light | on ultraviolet light | Reliability test | |
| | adhesive sheet | irradiation | irradiated surface | Peeling | Bubbling |
| Example 5 | PSA sheet-1 | Yes | PET | 4 | 5 |
| Example 6 | PSA sheet-2 | Yes | PET | 5 | 5 |
| Example 7 | PSA sheet-3 | Yes | PET | 5 | 4 |
| Reference | PSA sheet-1 | Yes | PMMA | 2 | 5 |
| example 1 | | | | | |
| Reference | PSA sheet-2 | Yes | PMMA | 4 | 5 |
| example 2 | | | | | |
| Reference | PSA sheet-3 | Yes | PMMA | 5 | 1 |
| example 3 | | | | | |
| Comparative | PSA sheet-1 | No | | 5 | 1 |
| example 2 | | | | | |
| Comparative | PSA sheet-2 | No | | 5 | 1 |
| example 3 | | | | | |
| Comparative | PSA sheet-3 | No | | 5 | 1 |
| example 4 | | | | | |
| Comparative | PSA sheet-4 | Yes | 1 | | |
| example 5 | | PET | | | |

Peeling was observed in comparative example 5 that used PSA sheet-4 that did not contain ultraviolet light absorbers. This is thought to be because cross-linking proceeded on both the first surface and the second surface. On the other hand, with examples 5 to 7, neither peeling nor bubbles were observed, or were only slightly observed. It is thought that bubbles were suppressed on the PET surface by placing the first surface that was irradiated with ultraviolet light and had a high cross-linked density at the PET side, and peeling from the PMMA surface was suppressed by placing the second surface which was not irradiated with ultraviolet light and had a low cross-linked density at the PMMA side.

### <Relationship Between Photoinitiator and Reliability Tests>

The type of photoinitiator and the amount of ultraviolet light irradiation were changed and then the reliability tests were performed. The samples were prepared according to the following procedures.

The 38 μm thick release film was peeled from PSA sheet-1, sheet-6, sheet-7, and sheet-8, and then a PET film (Lumirror (registered trademark) T60 produced by Toray, 188 μm thick) was applied by a rubber roller without performing ultraviolet light irradiation. The 50 μm release film on the opposite side was peeled off, and a PMMA sheet (Acrylite (registered trademark) MR 200 produced by Mitsubishi Rayon, 1.0 mm×55 mm×85 mm) was applied using a rubber roller. Next, treatment was performed for 30 minutes at 0.5 MPa and 40° C. using an autoclave.

Next, ultraviolet light irradiation was performed 1 time, 5 times, 10 times, and 20 times from the PET film side using an ultraviolet light irradiating device F-300 (H-bulb, 120 W/cm, 15 m/min) produced by Fusion UV Systems Japan.

The aforementioned reliability tests were performed using these samples. The results are shown in Table 5.

TABLE 5

| | Reliability test (bubbling) | | | |
|---|---|---|---|---|
| | UV | UV | UV | UV |
| | irradiation | irradiation | irradiation 10 | irradiation |
| | 1 time | 5 times | times | 20 times |
| PSA sheet-2 | 4 | 5 | | |
| PSA sheet-6 | 1 | 1 | 1 | 5 |
| PSA sheet-7 | 1 | 1 | 4 | 5 |
| PSA sheet-8 | 1 | 1 | 5 | 5 |

With PSA sheet-6 through sheet-8 that used benzophenone, sufficient cross-linking did not proceed without irradiating multiple times with ultraviolet light, and bubbles were confirmed.

Although the present invention has been described with reference to preferred embodiments, workers skilled in the art will recognize that changes may be made in form and detail without departing from the spirit and scope of the invention

1. A transparent pressure sensitive adhesive sheet comprising:
a first surface; and
a second surface,
wherein the transparent pressure sensitive adhesive sheet is obtained by ultraviolet light irradiation of an ultraviolet light hardening pressure sensitive adhesive sheet comprising:
a (meth)acrylic copolymer;
a cleavage type photoinitiator; and
an ultraviolet light absorber,
wherein the amount of ultraviolet light irradiation differs between the first surface and the second surface, and
wherein an adhesive force of the first surface and the second surface is different.

2. The transparent pressure sensitive adhesive sheet according to claim 1, wherein the cleavage type photoinitiator has a cleavage point that cleaves by ultraviolet light with a wavelength of 300 nm or more.

3. The transparent pressure sensitive adhesive sheet according to claim 1, wherein the (meth)acrylic copolymer has a hydroxyl group, and wherein the ultraviolet light hardening pressure sensitive adhesive sheet further comprises an ultraviolet light cross-linking agent with an isocyanate group.

4. The transparent pressure sensitive adhesive sheet according to claim 1, wherein the (meth)acrylic copolymer is essentially free of acrylic acid as a monomer component.

5. The transparent pressure sensitive adhesive sheet according to claim 1, wherein the ultraviolet light hardening pressure sensitive adhesive sheet further comprises a thermally sensitive cross-linking agent.

6. A laminate body comprising:
a first substrate;
a second substrate made from a different material than the first substrate; and
a transparent pressure sensitive adhesive sheet according to claim 1, having the first surface overlaid on a surface of the first substrate and the second surface overlaid on a surface of the second substrate.

7. The laminate body according to claim 6, wherein the first substrate is polyethylene terephthalate.

8. A manufacturing method for a laminate body comprising a first substrate, a second substrate and a transparent pressure sensitive adhesive sheet according to claim 1, wherein the transparent pressure sensitive adhesive sheet is provided between the first substrate and the second substrate, the method comprising:
a step of placing the ultraviolet light hardening pressure sensitive adhesive sheet adjacent to the first substrate;
a step of placing the second substrate adjacent to the ultraviolet light hardening pressure sensitive adhesive sheet;
a step of heating and/or compressing the ultraviolet light hardening pressure sensitive adhesive sheet, causing the ultraviolet light hardening pressure sensitive adhesive sheet to track to at least one of the first substrate and second substrate; and
a step of irradiating ultraviolet light at different amounts of ultraviolet light radiation onto a first surface and a second surface of the ultraviolet light hardening pressure sensitive adhesive sheet.
